(19) United States
(12) Patent Application Publication
(10) Pub. No.: US 2007/0176909 A1
(43) Pub. Date: Aug. 2, 2007

(54) Wireless Mobile Pen Communications Device With Optional Holographic Data Transmission And Interaction Capabilities

(75) Inventor: Eric John Pavlowski, Livermore, CA (US)

Correspondence Address: ERIC JOHN PAVLOWSKI, 3833 INGRAHAM STREET, APT# a210, SAN DIEGO, CA, 92109, US

(73) Assignee: Eric John Pavlowski, Livermore, CA (US)

(21) Appl. No.: 11/307,364

(22) Filed: Feb. 2, 2006

(51) Int. Cl. G06F 3/033

(52) U.S. Cl. 345/179

(57) ABSTRACT

A highly integrated and mobile wireless pen device for transmission, manipulation, visual and audio interaction of data with optional holographic data interface capabilities. A wireless pen device to interface with a desktop computer, laptop computer, cell phone, PDA, (personal digital assistant), Bluetooth device, IEEE 802.16 WiMax technology and protocols, or other electronic devices, systems, and/or communication infrastructures for the wireless and/or wired communications transmission of data (audio, visual, and information packets), with optional holographic data transmission and interaction capabilities. A highly integrated and mobile wireless pen device to advance and enrich the end-user experience for wireless and/or wired data communication, interaction (audio and visual), information technology, and manipulation. Features associated and integrated into the said wireless pen device or PCD, (personal communications device), include: an omni-directional antenna, Bluetooth technology communications circuitry, RF wireless transceiver communications circuitry, an ear bud jack, a USB port, a mobile re-chargeable DC power source, a microphone, an LCD digital display unit, a speaker with volume control, a removable and transferable micro data storage unit, flash memory, microprocessor, a digitizer for voice activation and recognition circuitry, a barcode scanner and/or data scanner, a micro camera, optional holographic circuitry, an optical lens, optical sensors, optical transceivers, an on/off optical sensor switch, a twist-lock pen cap with clip, laser pointer circuitry, a reading light, pressure sensor control circuitry for thumb interaction of data, an enter and/or data frame freeze button, a mounting I/O interface with a DC power adapter jack, and an optional quick release and adjustable wired and/or wireless I/O transceiver mounting stand with a DC power interface for hands-free operation and power management.

### FIELD OF THE INVENTION

This invention relates to a highly integrated and mobile wireless pen device for transmission, manipulation, visual and audio interaction of data with optional holographic data interface capabilities. A wireless pen device to interface with a desktop computer, laptop computer, cell phone, PDA, (personal digital assistant), Bluetooth device, IEEE 802.16 WiMax technology and protocols, or other electronic devices, systems, and/or communication infrastructures for the wireless and/or wired communications transmission of data, (audio, visual, and information packets), with optional holographic data transmission and interaction capabilities. A highly integrated and mobile wireless pen device to advance and enrich the end-user experience for wireless and/or wired data communication, interaction (audio and visual), information technology, and manipulation. Features associated and integrated into the said wireless pen device or PCD, (personal communications device), include: an omni-directional antenna, Bluetooth technology communications circuitry, RF wireless transceiver communications circuitry, an ear bud jack, a USB port, a mobile re-chargeable DC power source, a microphone, an LCD digital display unit, a speaker with volume control, a removable and transferable micro data storage unit, flash memory, microprocessor, a digitizer for voice activation and recognition circuitry, a barcode scanner and/or data scanner, a micro camera, optional holographic circuitry, an optical lens, optical sensors, optical transceivers, an on/off optical sensor switch, a twist-lock pen cap with clip, laser pointer circuitry, a reading light, pressure sensor control circuitry for thumb interaction of data, an enter and/or data frame freeze button, a mounting I/O interface with a DC power adapter jack, and an optional quick release and adjustable wired and/or wireless I/O transceiver mounting stand with a DC power interface for hands-free operation and power management.

### BACKGROUND OF THE INVENTION

The nature and scope of this invention has a plethora of positive phenomenal factors that will: revolutionize, change, enrich and improve the end-user experiences interfacing with a desktop computer, laptop computer, cell phone, PDA, (personal digital assistant), Bluetooth device, IEEE 802.16 WiMax technology and protocols, or other electronic devices, systems, and/or communication infrastructures for the wireless and/or wired communications transmission of data, (audio, visual, and information packets), with optional holographic data transmission and interaction capabilities.

The said wireless pen device will allow the end-user to not be tethered to other electronic equipment and/or communication infrastructures to interface and/or manipulate data. The end-user will experience a communication and information technology revolution that will allow the end-user to visually see data and hear data on a different interface medium instead of relying on desktops, laptops, PDAs, and/or other electronic devices. Instead of viewing information on the monitors of desktops, laptops, PDAs, and/or other electronic devices, data will be transmitted wirelessly and/or wired to the said wireless pen device and be projected from the pen. The data projection from the pen consists of two areas: 1) data projection from the said wireless pen device onto a “working surface” such as: a tablet, a screen, a blank wall, a piece of paper, etc. 2) data projection from the said wireless pen device as 3D (three dimensional) holographic data imagery. The 3D holographic data imagery projected from the said wireless pen device (a specific distance of resolution away) from the pen tip in air can further be: viewed, manipulated, rotated, stored, shared, transferred, transmitted and/or interfaced with other wireless and/or wired transmitted 3D holographic data imagery in real time. Such an example would include, but not be limited to a virtual holographic data network interface for business and/or personal means.

It is among the objects of the present invention to revolutionize data and communication interfaces by providing a highly integrated and mobile wireless pen device for transmission, manipulation, visual and audio interaction of data with optional holographic data interface capabilities to further enhance and enrich the end-user experiences.

### SUMMARY OF THE INVENTION

A feature of the present invention is a wireless mobile pen communications device with optional holographic data transmission and interaction capabilities. The present invention is a highly integrated and mobile wireless pen device for transmission, manipulation, visual and audio interaction of data with optional holographic data interface capabilities.

Another feature of the present invention is an ergonomic housing structure for said wireless pen containing circuitry and mechanical parts of the invention.

Another feature of the present invention is a removable twist-lock cap with clip on said pen. The twist-lock cap with clip provides: protection and shock absorption for optical sensors and lens, power management capabilities for said wireless pen by interfacing with the on/off optical sensor switch on pen tip, and a means for securing said pen to shirt pocket, pants pocket, or clipboard for portability.

Another feature of the present invention is an omni-directional antenna for Bluetooth and/or RF wireless communications interface between said pen and a desktop computer, laptop computer, cell phone, PDA, (personal digital assistant), Bluetooth device, IEEE 802.16 WiMax technology and protocols, or other electronic devices, systems, and/or communication infrastructures for the wireless and/or wired communications transmission of data, (audio, visual, and information packets), with optional holographic data transmission and interaction capabilities.

Another feature of the present invention is Bluetooth technology communications circuitry for wireless communications.

Another feature of the present invention is RF wireless transceiver communications circuitry for wireless communications.

Another feature of the present invention is an ear bud jack for audio listening of data.

Another feature of the present invention is a USB port on the distal portion of said pen for an optional wired communications interface.

Another feature of the present invention is a mobile re-chargeable DC power source.

Another feature of the present invention is a microphone for receiving audible information and/or in conjunction with voice activation/recognition circuitry applications.

Another feature of the present invention is an LCD digital display unit for: providing the end-user a means of viewing data (visual and information) transmitted, received or stored in the micro form-factor HDD, status of wireless or wired communications, connection strength, data rate, security protocol (type, enabled or disabled), time, date, and battery strength indicator.

Another feature of the present invention is a speaker with volume control circuitry to hear data.

Another feature of the present invention is a removable and transferable micro data storage unit.

Another feature of the present invention is flash memory to quickly store and retrieve data.

Another feature of the present invention is a microprocessor for highly integrated data acquisition and processing.

Another feature of the present invention is a digitizer for voice activation software and recognition circuitry via digitizing the audible data received by the microphone, and further digitizing printed data and/or information via the digitizer received by the barcode scanner and/or data scanner.

Another feature of the present invention is a barcode scanner and/or data scanner near the proximal end of the pen.

Another feature of the present invention is a micro camera near the proximal end of the pen.

Another feature of the present invention is optional holographic circuitry to transmit and project received Bluetooth and/or RF wireless communications data and/or wired data and information from an interface such as: a desktop computer, laptop computer, cell phone, PDA, (personal digital assistant), Bluetooth device, IEEE 802.16 WiMax technology and protocols, or other electronic devices, systems, and/or communication infrastructures in 3D (three dimensions) either onto a medium for visual display, and/or projected in air a specific distance away from the said pen lens that automatically adjusts for optimum resolution of the visual holographic data and information.

Another feature of the present invention is an optical lens on the proximal end of the said pen to aid in the transmission and resolution of wireless and/or wired transmitted data.

Another feature of the present invention is the use of optical sensors near the proximal end of the said pen to aid in the transmission and resolution of wireless and/or wired transmitted data as well as with holographic data transmission.

Another feature of the present invention is the use of optical transceivers near the proximal end of the said pen to aid in the transmission and resolution of wireless and/or wired transmitted data as well as with holographic data transmission.

Another feature of the present invention is an on/off optical sensor switch near the proximal end of the said pen for power management; the said pen is off (battery power is conserved) when the twist-lock pen cap is on; the said pen is on (battery power is consumed unless said pen is attached to the DC power adapter) when the twist-lock pen cap is off.

Another feature of the present invention is laser pointer circuitry to target data of interest for presentation purposes with a spot of light emitted from the pen.

Another feature of the present invention is a reading light for night use and/or applications of said pen in dark environments.

Another feature of the present invention is pressure sensor control circuitry for thumb interaction of data near the proximal end of the said pen for pointer and/or cursor control of data interaction, back, forward, scroll, x-coordinate functions, y-coordinate functions, x-y coordinate functions, and applications.

Another feature of the present invention is an enter and/or data frame freeze button near the proximal end of the said pen and adjacent to the pressure sensor control circuitry for thumb interaction of data to enter and/or lock and freeze wireless and/or wired interfaced data projected from said pen lens so the actual projected data window geometries will not change with time and/or if the said pen is moved from its original position while transmitting data.

Another feature of the present invention is a mounting I/O interface with a DC power adapter jack on the bottom and in the middle of said pen to interface I/O data and information (visual and audio) as well as providing a DC power interface for re-charging the power source on said pen with an optional quick release and adjustable wireless and/or wired I/O transceiver mounting stand with a DC power interface.

Another feature of the present invention is an optional quick release and adjustable wireless and/or wired I/O transceiver mounting stand with a DC power interface for hands-free operation and power management; the optional quick release and adjustable wireless and/or wired I/O transceiver mounting stand with a DC power interface connects directly to the mounting I/O interface with a DC power adapter jack on the bottom and in the middle of said pen.

These and further objects, features, and advantages of the present invention will become more readily apparent from the following detailed description of the illustrative embodiments of this invention when taken in conjunction with the accompanying drawings.

### BRIEF DESCRIPTION OF THE DRAWINGS

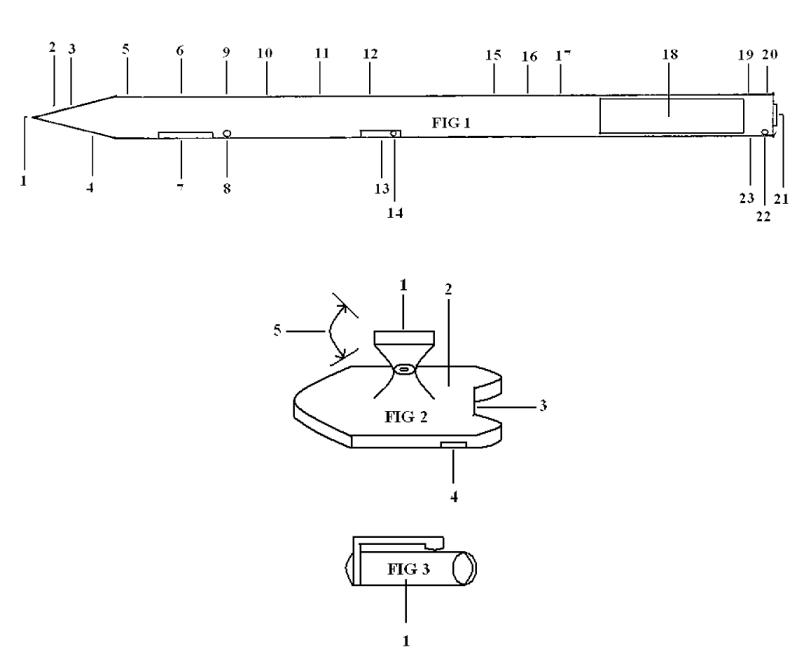

FIG. 1 shows the functional blocks, features, and elements of the wireless pen, consistent with an embodiment of the present invention. FIG. 1 shows:
1. Lens
2. Optical transceivers/optical sensors
3. Barcode scanner
4. Light/laser pointer circuitry
5. Holographic circuitry
6. DSP (digital signal processing circuitry)
7. Thumb control pressure pad of data/pagination
8. Enter button
9. Flash memory
10. Removable micro form-factor HDD (hard disk drive)
11. Microprocessor
12. DC power source
13. I/O port
14. DC power jack
15. Speaker
16. Volume control
17. Voice activation/recognition circuitry
18. LCD
19. Camera
20. Bluetooth technology communications circuitry, RF wireless communications circuitry, omni-directional antenna
21. USB port
22. Ear bud jack
23. Microphone

FIG. 2 is a diagram, illustrating an embodiment of the wireless pen quick release I/O and DC power mounting stand apparatus for hands-free operation. FIG. 2 shows:
1. I/O mounting port with DC power
2. Quick release I/O and DC power mounting stand (for hands-free operation)
3. DC power jack
4. USB port
5. Adjustable range of motion

FIG. 3 is a diagram, illustrating an embodiment of the wireless pen removable and lockable pen cap for: lens protection, triggering the on/off switch of the optical transceivers/optical sensors (pen cap on depicts off mode, pen cap removed depicts on mode), and attachment to clothing, etc., consistent with an embodiment of the present invention. FIG. 3 shows:
1 . wireless pen cap

### DETAILED DESCRIPTION

Reference will be presented in detail to the preferred embodiments of the present invention, examples of which are illustrated in the accompanying drawings. These embodiments are described in sufficient detail, and it is to be understood that other embodiments may be utilized without deviating from the scope and purpose of the present invention through electrical, ergonomic, material and mechanical changes; hence, the following detailed description should not be interpreted and/or comprehended to be in a limiting sense.

The present invention relates to a highly integrated and mobile wireless pen device for transmission, manipulation, visual and audio interaction of data with optional holographic data interface capabilities. A wireless pen device to interface with a desktop computer, laptop computer, cell phone, PDA, (personal digital assistant), Bluetooth device, IEEE 802.16 WiMax technology and protocols, or other electronic devices, systems, and/or communication infrastructures for the wireless and/or wired communications transmission of data, (audio, visual, and information packets), with optional holographic data transmission and interaction capabilities. A highly integrated and mobile wireless pen device to advance and enrich the end-user experience for wireless and/or wired data communication, interaction (audio and visual), information technology, and manipulation. Features associated and integrated into the said wireless pen device or PCD, (personal communications device), include: an omni-directional antenna, Bluetooth technology communications circuitry, RF wireless transceiver communications circuitry, an ear bud jack, a USB port, a mobile re-chargeable DC power source, a microphone, an LCD digital display unit, a speaker with volume control, a removable and transferable micro data storage unit, flash memory, microprocessor, a digitizer for voice activation and recognition circuitry, a barcode scanner and/or data scanner, a micro camera, optional holographic circuitry, an optical lens, optical sensors, optical transceivers, an on/off optical sensor switch, a twist-lock pen cap with clip, laser pointer circuitry, a reading light, pressure sensor control circuitry for thumb interaction of data, an enter and/or data frame freeze button, a mounting I/O interface with a DC power adapter jack, and an optional quick release and adjustable wired and/or wireless I/O transceiver mounting stand with a DC power interface for hands-free operation and power management.

In the embodiment of FIG. 1, functional blocks, features, and elements of the wireless pen is shown.

In the embodiment of FIG. 1, the tip of the wireless pen comprises the lens through which holographic data transmission (audio and visual) is transferred. The lens provides the user of the invention several means to: adjust and control how data and information is oriented and displayed by adjusting the physical position of the wireless pen, image quality and resolution. Optical transceivers and optical sensors are integrated into the wireless pen, behind the lens, and serve to transmit and receive holographic data (audio and visual). A barcode scanner is integrated into the wireless pen tip, and serves to scan data for: data storage, data manipulation, and data transfer to and from the said wireless pen. Light/laser pointer circuitry is also integrated into the wireless pen tip, and serves to provide the end-user a means of pointing to data or for illumination of data. Holographic circuitry is integrated into the wireless pen, and serves to provide the technological means of transferring and receiving holographic data (audio and visual) to and from the said wireless pen. DSP (digital signal processing circuitry) is also integrated into the wireless pen, and serves to provide the technological means of processing digital signals. In the front on the side of the wireless pen is where the thumb control pressure pad is located to provide the end-user a means of data pagination (scrolling) through the integration of a pressure sensor interface in the said wireless pen. The enter button is integrated into the wireless pen, oriented behind the thumb control pressure pad, and serves to provide the technological means of entering and/or freezing data. Flash memory is integrated into the wireless pen, and serves to provide the technological means of storing, transferring and receiving data to and from the said wireless pen. A removable and transferable micro form-factor HDD (hard disk drive), and HDD interface circuitry is integrated into the wireless pen, and serves to provide the technological means of storing, transferring and receiving data to and from the said wireless pen. A microprocessor, capable of supporting various threads of data and information at once, (hyper-threading), as well as holographic and/or wireless data packets is also integrated into the wireless pen. A re-chargeable, and long-lasting DC power source is integrated in the wireless pen, oriented in the middle for weight balance distribution at the center of gravity, and serves to provide constant, and un-interrupted DC power to all integrated components, circuitry, elements and features of the said wireless pen. An I/O port circuitry interface is integrated into the wireless pen, oriented in the middle on the bottom, and serves to provide the means to interface with the optional quick release I/O mounting stand for hands-free operation. The DC power jack interface is integrated into the wireless pen, oriented in the middle on the bottom, and serves to provide the means to connect with an external DC power transformer (when charging the integrated DC power source battery), as well as to interface with the optional quick-release mounting stand for hands-free operation. A micro form-factor speaker, located behind the middle of the pen, and oriented on top is integrated into the wireless pen, and serves to provide the end-user a means of listening to audio data and information. Volume control, oriented in close proximity to the micro form-factor speaker, is integrated into the wireless pen, and allows the end-user to adjust volume settings of audio data and information. Voice activation/recognition circuitry is integrated into the wireless pen, and serves to provide a means for the end-user to interface with the said wireless pen device for data manipulation and communications. An LCD display, integrated into the wireless pen, recessed and oriented in the back and on top, serves to provide the end-user a means of viewing data (visual and information): transmitted, received or stored in the micro form-factor HDD, status of wireless or wired communications, connection strength, data rate, security protocol (type, enabled or disabled), time, date, and battery strength indicator. A micro form-factor digital camera is integrated into the wireless pen, recessed and oriented in the back and on top of the said wireless pen, behind the LCD, serves to provide the end-user a means of capturing pictures, images, data, and/or information to be stored in memory, stored in the HDD or transmitted. Bluetooth technology, and RF wireless communications circuitry, in conjunction with an omni-directional antenna and USB port is integrated into the back of the wireless pen, and allows the end-user to: receive and transmit wireless and/or wired data packets and information to and from an external source interface: (e.g. laptop computer, desktop computer, cell phone, PDA (personal digital assistant), Bluetooth device, IEEE 802.16 WiMax technology and protocols, or other electronic devices, systems, and/or communication infrastructures for the wireless and/or wired communications transmission of data (audio, visual, and information packets). An ear bud jack integrated into the wireless pen, recessed and oriented in the back and on the bottom, serves to provide the end-user a means of connecting an optional ear bud to the said wireless pen for listening to audible data and information. A microphone integrated into the wireless pen, recessed and oriented in the back and on the bottom, serves to provide the end-user a means of interacting and interfacing with the said wireless pen by talking.

In the embodiment of FIG. 2, the optional quick release I/O mounting port and DC power interface stand for hands-free operation and power management of the wireless pen is shown.

In the embodiment of FIG. 2, the I/O mounting port with the DC power interface is located at the top of the optional quick release I/O mounting port and DC power interface stand for hands-free operation and power management of the wireless pen. The angle of the interface stand is adjusted by the position and orientation of the tightening screw or pin relative to the range of holes on the stand through which the end-user can choose. The I/O mounting port with the DC power interface stand has a range of motion of approximately 250 degrees. The DC power jack is located on the back of the base of the stand, and serves to provide the means to connect with an external DC power transformer (when charging the integrated DC power source battery of the said wireless pen). The USB port is integrated into the side of the optional quick release I/O mounting port and DC power interface stand and allows the end-user to: receive and transmit wireless and/or wired data packets and information to and from an external source interface: (e.g. laptop computer, desktop computer, cell phone, PDA (personal digital assistant), Bluetooth device, IEEE 802.16 WiMax technology and protocols, or other electronic devices, systems, and/or communication infrastructures for the wireless and/or wired communications transmission of data (audio, visual, and information packets).

In the embodiment of FIG. 3, the removable and lockable pen cap of the wireless pen is shown.

In the embodiment of FIG. 3, the pen cap of the wireless pen provides: lens protection, triggering the on/off switch of the optical transceivers/optical sensors (pen cap on depicts off mode, pen cap removed depicts on mode), and attachment to clothing, etc., consistent with an embodiment of the present invention.

The forgoing embodiments illustrated and described herein are merely exemplary and are not to be construed as limiting the present invention. The present teachings can be readily applied to other types of devices. The description of the present invention is intended to be illustrative, and not to limit the scope of the claims. Many alternatives, modifications, and variations within the scope and purpose of the invention will be apparent to those skilled in the art.

What is claimed is:

1. A highly integrated and mobile wireless pen device for transmission, manipulation, visual and audio interaction of data with optional holographic data interface capabilities, comprising:
a wireless pen;
a wireless pen device to interface with a desktop computer, laptop computer, cell phone, PDA, (personal digital assistant), Bluetooth device, IEEE 802.16 WiMax technology and protocols, or other electronic devices, systems, and/or communication infrastructures for the wireless and/or wired communications transmission of data, (audio, visual, and information packets), with optional holographic data transmission and interaction capabilities;
a) removable twist-lock cap with clip on said pen;
b) an ergonomic housing structure for said wireless pen circuitry and mechanical parts;
c) an omni-directional antenna;
d) Bluetooth technology communications circuitry;
e) RF wireless transceiver communications circuitry;
f) an ear bud jack;
g) a USB port;
h) a mobile re-chargeable DC power source;
i) a microphone;
j) an LCD digital display unit;
k) a speaker with volume control;
l) a removable and transferable micro data storage unit;
m) flash memory;
n) microprocessor;
o) a digitizer for voice activation and recognition circuitry;
p) a barcode scanner and/or data scanner;
q) a micro camera;
r) optional holographic circuitry;
s) an optical lens;
t) optical sensors;
u) optical transceivers;
v) an on/off optical sensor switch;
w) laser pointer circuitry;
x) a reading light;
y) pressure sensor control circuitry for thumb interaction of data;
z) an enter and/or data frame freeze button;
aa) a mounting I/O interface with a DC power adapter jack; and
ab) an optional quick release and adjustable wired and/or wireless I/O transceiver mounting stand with a DC power interface for hands-free operation and power management.

2. Device as defined by claim 1, wherein said ergonomic housing structure comprises all circuitry and mechanical parts for said wireless pen.

3. Device as defined by claim 1, wherein said removable twist-lock cap with clip on said pen provides: protection and shock absorption for optical sensors and lens, power management capabilities for said wireless pen by interfacing with the on/off optical sensor switch on pen tip, and a means for securing said pen to shirt pocket, pants pocket, or clipboard for portability.

4. Device as defined by claim 1, wherein said wireless pen further comprises an omni-directional antenna for Bluetooth and/or RF wireless communications interface between said pen and a desktop computer, laptop computer, cell phone, PDA, (personal digital assistant), Bluetooth device, IEEE 802.16 WiMax technology and protocols, or other electronic devices, systems, and/or communication infrastructures for the wireless and/or wired communications transmission of data, (audio, visual, and information packets), with optional holographic data transmission and interaction capabilities; the omni-directional antenna being in communication with the microprocessor and power source.

5. Device as defined by claim 1, wherein said wireless pen further comprises Bluetooth technology communications circuitry; the Bluetooth technology communications circuitry being in communication with the microprocessor and power source.

6. Device as defined by claim 1, wherein said wireless pen further comprises RF wireless transceiver communications circuitry; the RF wireless transceiver communications circuitry being in communication with the microprocessor and power source.

7. Device as defined by claim 1, wherein said wireless pen further comprises an ear bud jack for audio listening of data; the ear bud jack being in communication with the microprocessor and power source.

8. Device as defined by claim 1, wherein said wireless pen further comprises a USB port on the distal portion of said pen for an optional wired communications interface; the USB port being in communication with the microprocessor and power source.

9. Device as defined by claim 1, wherein said wireless pen further comprises a mobile re-chargeable DC power source.

10. Device as defined by claim 1, wherein said wireless pen further comprises a microphone for receiving audible information; the microphone being in communication with the microprocessor and power source.

11. Device as defined by claim 1, wherein said wireless pen further comprises an LCD digital display unit for: providing the end-user a means of viewing data (visual and information) transmitted, received or stored in the micro form-factor HDD, status of wireless or wired communications, connection strength, data rate, security protocol (type, enabled or disabled), time, date, and battery strength indicator; the LCD digital display unit being in communication with the microprocessor and power source.

12. Device as defined by claim 1, wherein said wireless pen further comprises a speaker with volume control circuitry; the speaker and volume control circuitry being in communication with the microprocessor and power source.

13. Device as defined by claim 1, wherein said wireless pen further comprises a removable and transferable micro data storage unit; the removable and transferable micro data storage unit being in communication with the microprocessor and power source.

14. Device as defined by claim 1, wherein said wireless pen further comprises flash memory; flash memory being in communication with the microprocessor and power source.

15. Device as defined by claim 1, wherein said wireless pen further comprises a microprocessor; the microprocessor being in communication with the power source.

16. Device as defined by claim 1, wherein said wireless pen further comprises a digitizer for voice activation software and recognition circuitry via digitizing the audible data received by the microphone, and further digitizing printed data and/or information via the digitizer received by the barcode scanner and/or data scanner; the digitizer further being in communication with the microprocessor and power source.

17. Device as defined by claim 1, wherein said wireless pen further comprises a barcode scanner and/or data scanner near the proximal end of the pen; the barcode scanner and/or data scanner being in communication with the microprocessor and power source.

18. Device as defined by claim 1, wherein said wireless pen further comprises a micro camera near the proximal end of the pen; the micro camera being in communication with the microprocessor and power source.

19. Device as defined by claim 1, wherein said wireless pen further comprises optional holographic circuitry to transmit and project received Bluetooth and/or RF wireless communications data and/or wired data and information from an external interface such as: a desktop computer, laptop computer, cell phone, PDA, (personal digital assistant), Bluetooth device, IEEE 802.16 WiMax technology and protocols, or other electronic devices, systems, and/or communications infrastructure in 3D (three dimensions) either onto a medium for visual display, and/or projected in air a specific distance away from the said wireless pen lens that automatically adjusts for optimum resolution of the visual holographic data and information; the optional holographic circuitry further being in communication with the microprocessor and power source.

20. Device as defined by claim 1, wherein said wireless pen further comprises an optical lens on the proximal end of the said pen; the optical lens being in communication with the microprocessor and power source.

21. Device as defined by claim 1, wherein said wireless pen further comprises optical sensors near the proximal end of the said pen; the optical sensors being in communication with the microprocessor and power source.

22. Device as defined by claim 1, wherein said wireless pen further comprises optical transceivers near the proximal end of the said pen; the optical transceivers being in communication with the microprocessor and power source.

23. Device as defined by claim 1, wherein said wireless pen further comprises an on/off optical sensor switch near the proximal end of the said pen for power management; the said pen is off (battery power is conserved) when the twist-lock pen cap is on; the said pen is on (battery power is consumed unless said pen is attached to the DC power adapter) when the twist-lock pen cap is off; the on/off optical sensor switch further being in communication with the microprocessor and power source.

24. Device as defined by claim 1, wherein said wireless pen further comprises laser pointer circuitry to target data of interest for presentation purposes with a spot of light emitted from the pen; the laser pointer circuitry being in communication with the microprocessor and power source.

25. Device as defined by claim 1, wherein said wireless pen further comprises a reading light for night use and/or applications of said pen in dark environments; the reading light being in communication with the microprocessor and power source.

26. Device as defined by claim 1, wherein said wireless pen further comprises pressure sensor control circuitry for thumb interaction of data near the proximal end of the said pen for pointer and/or cursor control of data interaction, back, forward, scroll, x-coordinate functions, y-coordinate functions, x-y coordinate functions, and applications; the pressure sensor control circuitry for thumb interaction of data further being in communication with the microprocessor and power source.

27. Device as defined by claim 1, wherein said wireless pen further comprises an enter and/or data frame freeze button near the proximal end of the said pen and adjacent to the pressure sensor control circuitry for thumb interaction of data to enter and/or lock and freeze wireless and/or wired interfaced data projected from said pen lens so the actual projected data window geometries will not change with time and/or if the said pen is moved from its original position while transmitting data; the enter and/or data frame freeze button further being in communication with the microprocessor and power source.

28. Device as defined by claim 1, wherein said wireless pen further comprises a mounting I/O interface with a DC power adapter jack on the bottom and in the middle of said pen to interface I/O data and information (visual and audio) as well as providing a DC power interface for re-charging the power source on said pen with an optional quick release and adjustable wireless and/or wired I/O transceiver mounting stand with a DC power interface; the mounting I/O interface with a DC power adapter jack further being in communication with the microprocessor and power source.

29. Device as defined by claim 1, wherein said wireless pen further comprises an optional quick release and adjustable wireless and/or wired I/O transceiver mounting stand with a DC power interface for hands-free operation and power management; the optional quick release and adjustable wireless and/or wired I/O transceiver mounting stand with a DC power interface connects directly to the mounting I/O interface with a DC power adapter jack on the bottom and in the middle of said pen; the optional quick release and adjustable wireless and/or wired I/O transceiver mounting stand with a DC power interface for hands-free operation and power management further being in communication with the microprocessor and power source when connected to said pen.
